(19) United States
(12) Patent Application Publication
(10) Pub. No.: US 2018/0164863 A1
(43) Pub. Date: Jun. 14, 2018

(54) POWER CONSUMPTION TESTING SYSTEM AND POWER CONSUMPTION TESTING METHOD FOR WIRELESS MOUSE

(71) Applicant: Primax Electronics Ltd., Taipei (TW)

(72) Inventors: Pei-Ming Chang, Taipei (TW); Shih-Chieh Hsu, Taipei (TW); Shi-Jie Zhang, Taipei (TW); Wei-Lung Huang, Taipei (TW)

(21) Appl. No.: 15/464,335

(22) Filed: Mar. 20, 2017

(30) Foreign Application Priority Data
Dec. 14, 2016 (TW) 105141382

(51) Int. Cl. G06F 1/26; G06F 3/0354; G06F 11/22; G06F 1/28

(52) U.S. Cl. CPC G06F 1/263; G06F 1/28; G06F 11/2284; G06F 3/03543

(57) ABSTRACT

The present invention provides a power consumption testing system and a power consumption testing method for a wireless mouse. The power consumption testing system includes: a platform; a flexible thin sheet; a first movable fixed component; a second movable fixed component; a vibration motor; and a processing apparatus. The first movable fixed component is configured to connect the flexible thin sheet and the platform. The second movable fixed component is configured to connect the wireless mouse to the flexible thin sheet or the platform. The vibration motor is connected to the flexible thin sheet and is configured to shake the flexible thin sheet so that the wireless mouse continuously moves on the flexible thin sheet. The processing apparatus is wirelessly connected to the wireless mouse and is configured to read and record a voltage value of the wireless mouse to determine a battery capacity of the wireless mouse.

### BACKGROUND OF THE INVENTION

### 1. Field of the Invention

The present invention relates to a power consumption testing system and a related power consumption testing method, and more particularly to a power consumption testing system and a power consumption testing method for a wireless mouse.

### 2. Description of the Prior Art

Generally, a conventional power consumption testing method and system for a wireless mouse uses a complicated automated testing device to continuously move the wireless mouse, to simulate an actual operation status of the wireless mouse and collect statistics of a power consumption situation by means of this. However, an automated testing device in conventional technologies has disadvantages of high costs and complicated operations.

### SUMMARY OF THE INVENTION

In view of the above, an object of the present invention provides a power consumption testing system and a power consumption testing method for a wireless mouse, to make a process for testing power consumption of the wireless mouse easier and have low costs, to resolve the foregoing problem.

Claims of the present invention disclose a power consumption testing system for a wireless mouse. The power consumption testing system includes: a platform; a flexible thin sheet; a first movable fixed component; a second movable fixed component; a vibration motor; and a processing apparatus. The first movable fixed component is configured to connect the flexible thin sheet and the platform. The second movable fixed component is configured to connect the wireless mouse to the flexible thin sheet or the platform. The vibration motor is connected to the flexible thin sheet and is configured to shake the flexible thin sheet so that the wireless mouse continuously moves on the flexible thin sheet. The processing apparatus is wirelessly connected to the wireless mouse and is configured to read and record a voltage value of the wireless mouse to determine a battery capacity of the wireless mouse.

The claims of the present invention disclose a power consumption testing method for a wireless mouse. The power consumption testing method includes: connecting a flexible thin sheet and a platform by using a first movable fixed component; connecting the wireless mouse to the flexible thin sheet or the platform by using a second movable fixed component; shaking the flexible thin sheet by using a vibration motor so that the wireless mouse continuously moves on the flexible thin sheet; and reading and recording a voltage value of the wireless mouse by using a processing apparatus to determine a battery capacity of the wireless mouse.

In conclusion, the power consumption testing system and the power consumption testing method disclosed in the present invention can make a process for testing power consumption of the wireless mouse easier and have low costs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simple schematic diagram of a power consumption testing system for a wireless mouse according to an embodiment of the present invention.

FIG. 2 is a schematic flowchart that summarizes an embodiment of a power consumption testing method for a wireless mouse of the present invention according to a manner for running the power consumption testing system in FIG. 1.

### DETAILED DESCRIPTION

Some words are used in the present patent specification and claims to refer to particular components. A person of general knowledge in the art should understand that a hardware manufacturer may use different nouns to call a same component. The present patent specification and claims do not use differences between names as a manner for distinguishing components but use functional differences as a rule for distinguishing. “Include” or “comprise” mentioned in the whole specification and claims are open wordings and therefore, should be explained as “including but not limited to”.

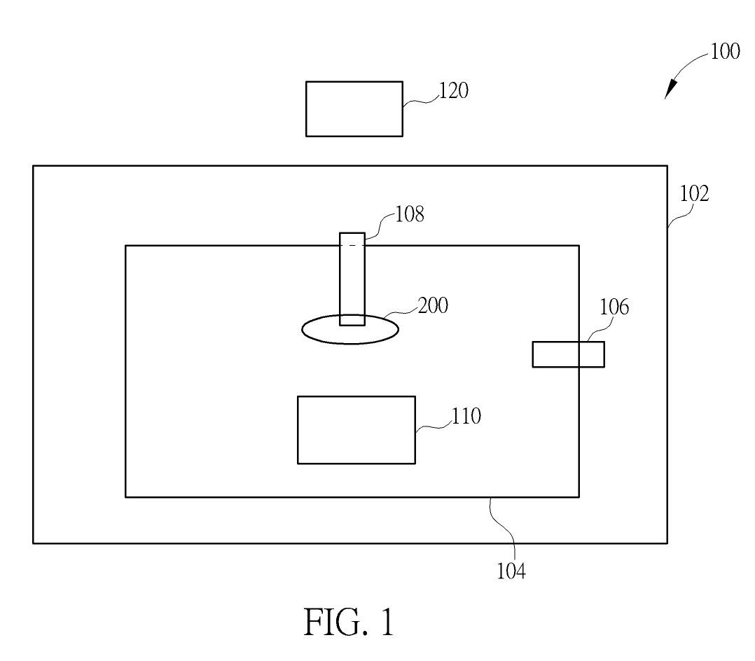

Referring to FIG. 1, FIG. 1 is a simple schematic diagram of a power consumption testing system 100 for a wireless mouse 200 according to an embodiment of the present invention. As shown in FIG. 1, the power consumption testing system 100 includes: a platform 102, a flexible thin sheet 104, a first movable fixed component 106, a second movable fixed component 108, a vibration motor 110, and a processing apparatus 120. The platform 102 may be a worktable or a floor. The flexible thin sheet 104 may be a paper or a plastic sheet. The first movable fixed component 106 and the second movable fixed component 108 may be adhesive tapes. The vibration motor 110 may be an eccentric electric motor, and the processing apparatus 120 may be a computer or a smartphone. The first movable fixed component 106 is configured to connect the flexible thin sheet 104 to the platform 102. The second movable fixed component 108 is configured to connect the wireless mouse 200 to the flexible thin sheet 104 or the platform 102. The vibration motor 110 is connected to the flexible thin sheet 104 and is configured to shake the flexible thin sheet 104 so that the wireless mouse 200 continuously moves on the flexible thin sheet 104. The vibration motor 110 may also be connected to the flexible thin sheet 104 by using an adhesive tape. The processing apparatus 120 is wirelessly connected to the wireless mouse 200 and is configured to read and record a voltage value of the wireless mouse 200 to determine a battery capacity of the wireless mouse 200. For example, an adhesive tape is used to fasten a particular edge of a paper to a worktable. In this way, the paper has a fixed end and a corresponding free end. Therefore, the paper can be shaken, and for example, perform reciprocating periodic motion. One end of the wireless mouse may be fixedly connected to the paper or the worktable, so that the wireless mouse has a fixed end and a free end. The free end is driven by the paper to continuously move, and the fixed end makes the wireless mouse not separated from the paper under moving for long time. Then the eccentric electric motor produces periodic motion to drive the paper to move and makes the wireless mouse and the paper relatively displace. The processing apparatus is wirelessly connected to the wireless mouse, and the processing apparatus has an application, which can read and record a voltage value of the wireless mouse by means of wireless connection and determine a battery capacity of the wireless mouse.

It should be noted herein that the foregoing embodiments are only used as examples for description of the present invention and are not limitation conditions of the present invention. For example, the platform 102, the flexible thin sheet 104, the first movable fixed component 106, the second movable fixed component 108, and the processing apparatus 120 all can be replaced by other components having similar functions according to different design demands.

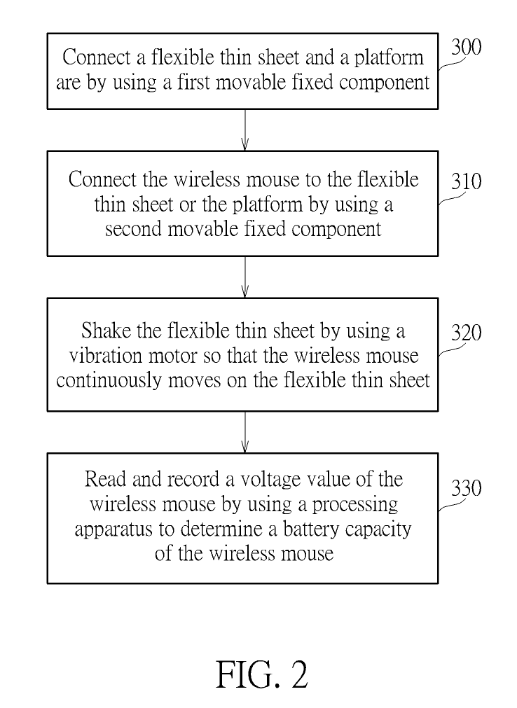

Referring to FIG. 2, FIG. 2 is a schematic flowchart that summarizes an embodiment of a power consumption testing method for a wireless mouse of the present invention according to a manner for running the power consumption testing system 100. It is assumed that a roughly same result can be obtained, steps in a process do not necessarily need to be executed according to the sequence shown in FIG. 2 and do not necessarily need to be continuous. That is, other steps can be inserted into these steps. The power consumption testing method of the present invention includes the following steps:

In a step 300, a flexible thin sheet and a platform are connected by using a first movable fixed component.

In a step 310, the wireless mouse is connected to the flexible thin sheet or the platform by using a second movable fixed component.

In a step 320, the flexible thin sheet is shaken by using a vibration motor so that the wireless mouse continuously moves on the flexible thin sheet.

In a step 330, a voltage value of the wireless mouse is read and recorded by using a processing apparatus to determine a battery capacity of the wireless mouse.

In conclusion, the power consumption testing system and the power consumption testing method disclosed in the present invention can make a process for testing power consumption of the wireless mouse easier and have low costs.

The foregoing descriptions are merely exemplary embodiments of the present invention. Variations and modifications made according to the claims of the present invention should be all within coverage of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power consumption testing system for a wireless mouse, comprising:
a platform;
a flexible thin sheet;
a first movable fixed component, configured to connect the flexible thin sheet and the platform;
a second movable fixed component, configured to connect the wireless mouse to the flexible thin sheet or the platform;
a vibration motor, connected to the flexible thin sheet and configured to shake the flexible thin sheet so that the wireless mouse continuously moves on the flexible thin sheet; and
a processing apparatus, wirelessly connected to the wireless mouse and configured to read and record a voltage value of the wireless mouse to determine a battery capacity of the wireless mouse.

2. The power consumption testing system according to claim 1, wherein the flexible thin sheet is a paper or a plastic sheet.

3. The power consumption testing system according to claim 1, wherein the vibration motor is an eccentric electric motor.

4. The power consumption testing system according to claim 1, wherein the first movable fixed component and the second movable fixed component are adhesive tapes.

5. A power consumption testing method for a wireless mouse, comprising:
connecting a flexible thin sheet and a platform by using a first movable fixed component;
connecting the wireless mouse to the flexible thin sheet or the platform by using a second movable fixed component;
shaking the flexible thin sheet by using a vibration motor so that the wireless mouse continuously moves on the flexible thin sheet; and
reading and recording a voltage value of the wireless mouse by using a processing apparatus to determine a battery capacity of the wireless mouse.

6. The power consumption testing method according to claim 5, wherein the flexible thin sheet is a paper or a plastic sheet.

7. The power consumption testing method according to claim 5, wherein the vibration motor is an eccentric electric motor.

8. The power consumption testing method according to claim 5, wherein the first movable fixed component and the second movable fixed component are adhesive tapes.
